(19) United States
(12) Patent Application Publication
(10) Pub. No.: US 2003/0208561 A1
(43) Pub. Date: Nov. 6, 2003

(54) Counterfeit STB prevention through protocol switching

(76) Inventors: Khoi Hoang, Pleasanton, CA (US); Tony Qu, San Ramon, CA (US)

Correspondence Address: OPPENHEIMER WOLFF & DONNELLY, P. O. BOX 10356, PALO ALTO, CA, 94303, US

(21) Appl. No.: 09/892,015

(22) Filed: Jun. 25, 2001

Related U.S. Application Data
(63) Continuation-in-part of application No. 09/870,879, filed on May 30, 2001.
(63) Continuation-in-part of application No. 09/841,792, filed on Apr. 24, 2001.
(63) Continuation-in-part of application No. 09/709,948, filed on Nov. 10, 2000.
(63) Continuation-in-part of application No. 09/584,832, filed on May 31, 2000, now Pat. No. 6,557,030.

(51) Int. Cl. G06F 15/16

(52) U.S. Cl. 709/219; 709/229; 713/200

(57) ABSTRACT

The present invention teaches a universal STB operative to prevent unauthorized access to digital broadcast data including: a databus; a first communication device suitable for coupling to a digital broadcast communications medium, the first communication device operable to receive digital broadcast data; memory bi-directionally coupled to the databus, the memory including computer executable instructions for: a). determining whether the STB is authentic or counterfeit; b). performing anti-counterfeit measures upon the STB when the device is determined to be counterfeit; and c). updating a communications protocol of the STB when the STB is determined to be authentic; a digital data decoder bi-directionally coupled to the databus; a central processing unit (CPU) bi-directionally coupled to the databus, the CPU implementing a STB control process controlling the memory, the first communications device and the digital decoder, the STB control process operable to process digital data received at the first communications device.

### RELATED APPLICATIONS

This application is a continuation-in-part claiming priority to Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all three being incorporated herein by reference.

### BACKGROUND OF THE INVENTION

1. Field of the Invention

The present invention relates to data-on-demand (DOD) and digital broadcast technology.

In particular, the present invention teaches a method for preventing counterfeit set-top-boxes (STBs) from pirating proprietary data transmissions.

2. Description of the Prior Art

A variety of mechanisms are available for verifying the authenticity of set top boxes for receiving video on demand (VOD) programs for display on a television or other video display device. One problem faced in the VOD and DOD industry is the counterfeiting of the STB and the pirating of the signal. Traditional uni-directional communications, such as cable, have had many problems in attempting to stop people from pirating cable. The advent of the STB allowed a mixed signal to be sent only to persons with a STB capable of de-scrambling the signal would be able to decode the signal properly. However, a counterfeit STB could still be used to de-scramble the signal. Using bi-directional communications allowed for a certain level of authenticity verification, however this would use significant processing and bandwidth resources and will not work in uni-directional systems.

The following is a general discussion of widely used digital broadcast systems.

Generally in digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base. The transport streams are encrypted so that only an authentic STB may decipher them.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112.

PRIOR ART FIG. 2 is a block schematic showing a digital broadcast system 200 including a digital broadcast server 202 and a set-top-box 204 suitable for processing digital broadcast data. At the digital broadcast server 202, video data is provided to a video encoder 206 which encodes the video data in accordance with the MPEG-2 standard. The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data. The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a VOD system 300. At the heart of the VOD system 300 is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The VOD system 300 also includes a plurality of VOD STBs 304 suitable for processing VOD in the VOD system 300. Each STB 304 receives and decodes a digital movie and converts it to a signal for display on a TV set or monitor.

The typical model for digital broadcast and DOD systems described above adheres to what is termed a “bi-directional client-server model.” In order to point out defects inherent to this prior art system, the typical hardware architecture generic to such a DOD system will be described below with reference to FIG. 4. Further, a pair of methods for controlling the prior art DOD server and the prior art DOD client will be described below with reference to FIG. 5 and FIG. 6, respectively.

PRIOR ART FIG. 4 illustrates a general diagram of a DOD system 320 having a bi-directional client-server architecture. The DOD system 322 includes a DOD server 322 bi-directionally coupled with a plurality of DOD clients 324 vi a communication link 326. As will be appreciated, the VOD system 300 of FIG. 3 is a somewhat specific example of the DOD system 320.

Broadly speaking, the DOD system 320 operation adheres to the well known client-server model as follows. In some manner, typically through transmission of an Electronic Program Guide (EPG) by the DOD server 322, the clients 324 are informed of available on-demand data. Using the EPG for reference, a requesting DOD client 324 requests specific data from the DOD server 322 via the communication link 326. The DOD server 322 interprets the client request, and then prepares the client specific data in a format suitable for use by the requesting client 324.

Once the client specific data is prepared, the server 322 transmits the client specific data to the requesting client 324. The requesting client 324 receives, via a specifically allocated portion of the communication link 326, the requested client specific data in a readably usable format. The requested client specific data is provided in a format ready for presentation by the DOD client to the end user. These client-server processes are described below in more detail with reference to FIGS. 5-6.

Under the client-server model of FIG. 4, the available bandwidth of communication link 326 must be divided up into allocated portions 328, each allocated portion being dedicated to a particular client. Hence the bandwidth required for prior art DOD systems is directly proportional to the number of clients being served.

Although communication link 326 may be a true bi-directional communications medium, such infrastructure is uncommon. Instead, typical implementations today cobble together existing infrastructure such as fiber optic cabling and telephone lines to implement the necessary bi-directional communications. For example, the fiber optic cable may be used for server transmission of client specific data while an existing telephone line may be used for client transmission of requests.

Turning next to PRIOR ART FIG. 5, a DOD server method 340 in accordance with the prior art will now be described. In a first step 342, the DOD server identifies the available slots within the available transmission bandwidth. In a next step 344 the DOD server prepares and transmits a suitable EPG to each client. It will be appreciated that different EPGs may be transmitted for different clients depending upon factors such as subscription levels, available services, personalized settings, payment history, etc. In any event, in a next step 346, the DOD server receives a demand for specific data from a specific client. The demand includes information indicating the identity of the client. Then in a step 348, the DOD server identifies the specific client from information included with the demand.

At a step 350, a determination is made whether the client is authorized to receive the requested data. If the client is authorized to receive data, the process proceeds to step 351. In step 351, the DOD server assigns an available slot to the authentic client. In step 352, the DOD server prepares the requested client specific data for transmission in a format suitable for the requesting client. Step 348 may include such actions as retrieving the client specific data from a persistent storage mechanism and preparing an appropriate channel server for data transmission. Continuing with a step 354, the DOD server transmits the client specific data via the bandwidth allocated to the requesting client.

If the client is not authorized to receive the requested data, or the client is using a counterfeit STB, the process proceeds to step 356, where the DOD server transmits a generic message stating that the service is unavailable. Other appropriate data may also be transmitted.

Turning next to FIG. 6, a client method 360 for retrieving on-demand data will now be described. In a tuning step 362, the DOD client will tune into the appropriate channel program and in a receiving step 364 the DOD client will receive the EPG transmitted by the DOD server. In a next step 366, the DOD client provides the EPG information to a DOD user and in a step 368, receives a request for specific data from the DOD user. Then in a step 370, the DOD client demands that the DOD server provide the requested client specific data. In a step 372, in anticipation of the requested client specific data, the DOD client tunes into the allocated bandwidth. Then in a step 374, the DOD client receives via allocated bandwidth the requested client specific data in a readably usable format and provides it to the DOD user.

In uni-directional broadcast systems, broadcasters encrypt transmissions in order to prevent counterfeit STBs from deciphering their transmissions. The authentic STBs having either software or hardware capable of deciphering the transmissions. The problem with this method is that sophisticated counterfeiters are able to acquire and analyze authentic STBs in order to fabricate counterfeit STBs capable of deciphering the encrypted transmissions.

As the above discussion reflects, none of the prior art systems provide a method for preventing counterfeit STBs from accessing DOD services without relying on bi-directional communication. Therefore, it is desirable to provide a method for preventing counterfeit STBs from accessing data from a DOD system without relying on bi-directional communication. Furthermore, it is desirable to provide a method for disabling counterfeit STBs. What is also needed is a method for preventing counterfeit STBs from accessing DOD services in a unidirectional broadcast system. What is further needed is a method for updating an STB so that it may decipher encrypted data.

### SUMMARY

The present invention teaches methods and systems for preventing counterfeit STBs from accessing data from a DOD system without relying on bi-directional communication. The present invention also teaches methods and systems for preventing counterfeit STBs from accessing DOD services in a unidirectional broadcast system and for disabling counterfeit STBs. These include a universal digital data system, a universal STB, and a variety of methods for handling these digital services and controlling the universal STB.

A first embodiment of the present invention teaches a universal STB operative to prevent unauthorized access to digital broadcast data. The architecture of this STB includes: a databus; a first communication device suitable for coupling to a digital broadcast communications medium, the first communication device operable to receive digital broadcast data; memory bi-directionally coupled to the databus, the memory including computer executable instructions for: a). determining whether the STB is authentic or counterfeit; b). performing anti-counterfeit measures upon the STB when the device is determined to be counterfeit; and c). updating a communications protocol of the STB when the STB is determined to be authentic; a digital data decoder bi-directionally coupled to the databus; a central processing unit (CPU) bi-directionally coupled to the databus, the CPU implementing a STB control process controlling the memory, the first communications device and the digital decoder, the STB control process operable to process digital data received at the first communications device.

In a refinement of the current invention, the STB includes an STB authenticity code hidden with the STB hardware, wherein the computer executable instructions for determining whether the STB is authentic or counterfeit includes a computer executable instruction for performing an integrity check upon the hidden STB authenticity code.

In a further refinement of the present invention, wherein performing anti-counterfeit measures upon the STB when the device is determined to be counterfeit includes transmitting a signal to a broadcast server site indicating that the STB is counterfeit.

It is important to remark that as types of set-top boxes become more ubiquitous, they are often built-in to a unit, such as a TV or computer, rather than actually set on top or beside. One of ordinary skill in the art would recognize that all references to STBs would apply equally to built-in version, and thus the two become synonymous.

### BRIEF DESCRIPTION OF THE DRAWINGS

PRIOR ART FIG. 1 illustrates pictorially the packetizing of compressed video data into a stream of packets and a stream of transport packets;

PRIOR ART FIG. 2 illustrates by block diagram a system according to the MPEG-2 standard;

PRIOR ART FIG. 3 illustrates a simplified functional block diagram of a VOD system;

PRIOR ART FIG. 4 illustrates a DOD system adhering to a prior art bi-directional client-server architecture;

PRIOR ART FIG. 5 illustrates a DOD server method for preventing the receipt of DOD data by counterfeit STBs using a bi-directional, client specific data transmission mechanism;

PRIOR ART FIG. 6 illustrates a DOD client method for receiving and processing client specific data via a bi-directional transmission mechanism;

FIG. 7 is a block diagram of a digital broadcast server in accordance with one embodiment of the present invention;

FIG. 8 is a block diagram showing the hardware architecture of a universal STB in accordance with yet another embodiment of the present invention;

FIG. 9 is a flow chart illustrating a computer implemented method for updating a communications protocol of a broadcast system in accordance with the present invention;

FIG. 10 is a flow chart illustrating a computer implemented method for updating a communications protocol of a STB in accordance with the present invention; and

FIG. 11 is a flow chart illustrating a computer executable method for executing the protocol update software in accordance with the method illustrated in FIG. 10.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for preventing counterfeit STBs from accessing data from a DOD system without relying on bi-directional communication. The present invention also teaches methods and systems for preventing counterfeit STBs from accessing DOD services in a uni-directional broadcast system and for disabling counterfeit STBs. These include a universal digital data system, a universal STB, and a variety of methods for handling these digital services and controlling the universal STB. However, those skilled in the art will recognize that all aspects of the present invention can be implemented within the bi-directional communication paradigm, the only difference being that even further features can be provided to the digital broadcast and DOD user when a bi-directional communication link is available.

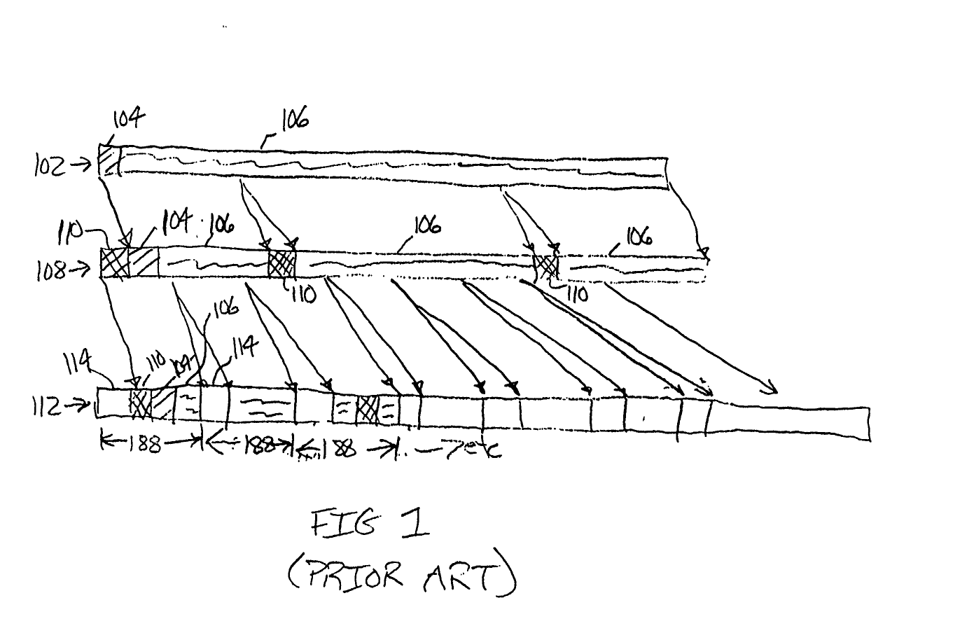

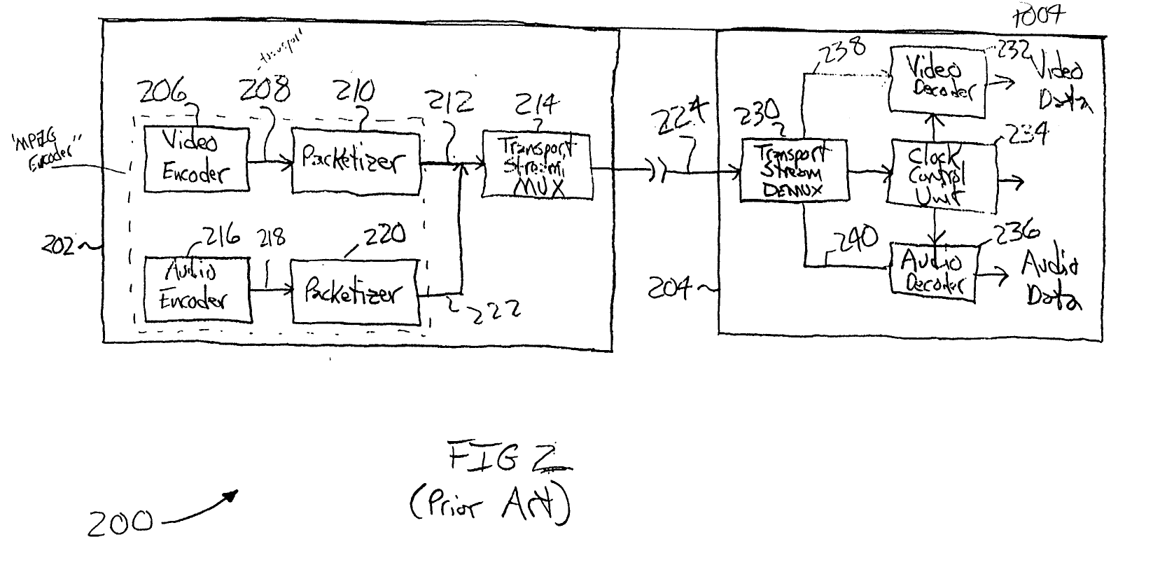

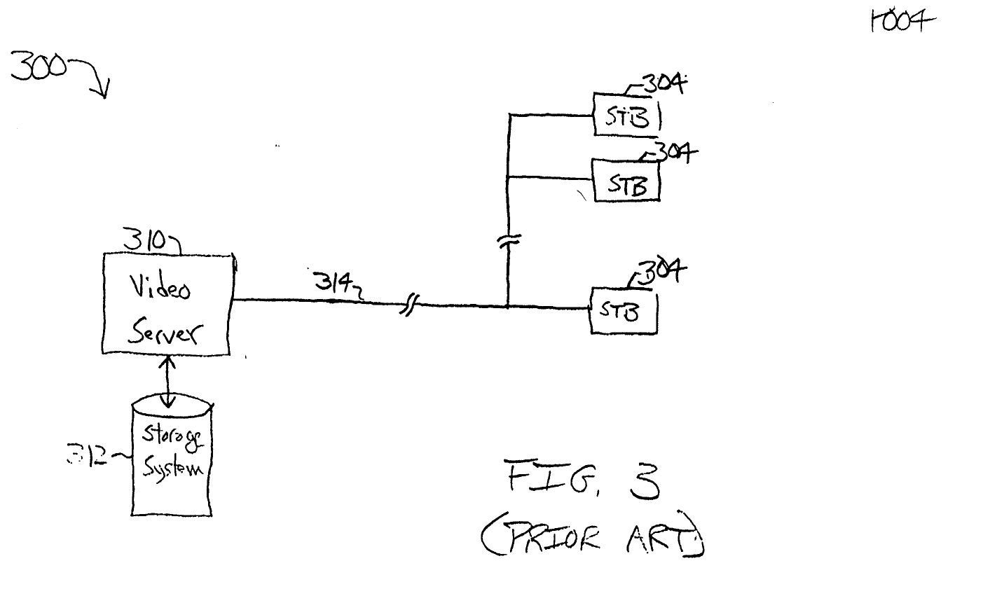

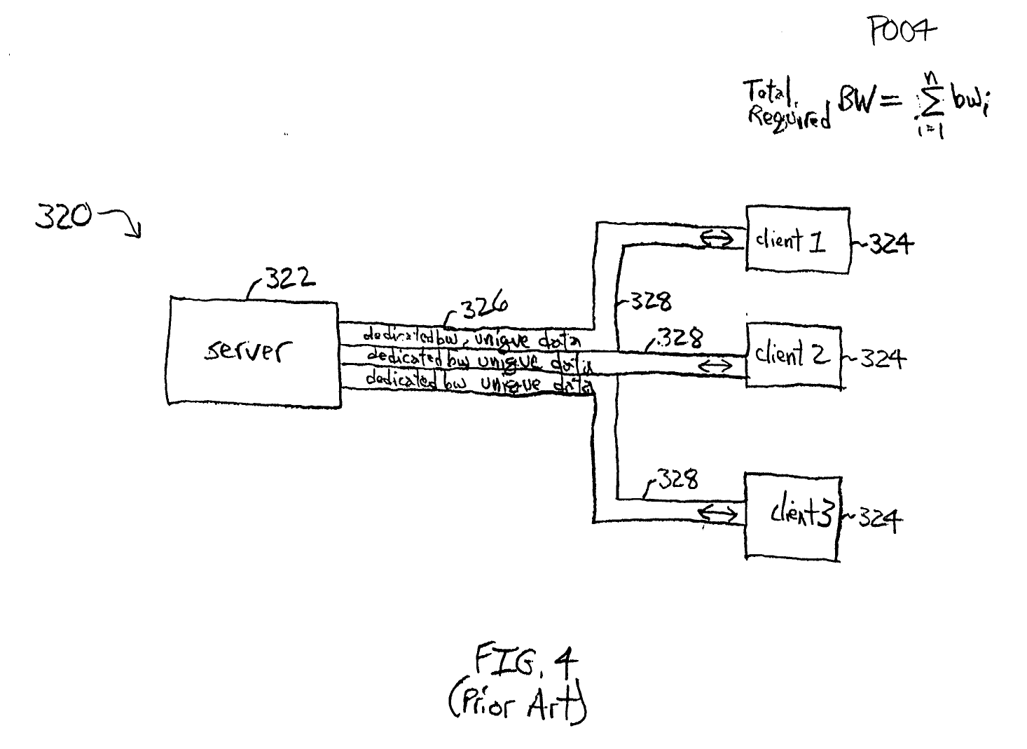

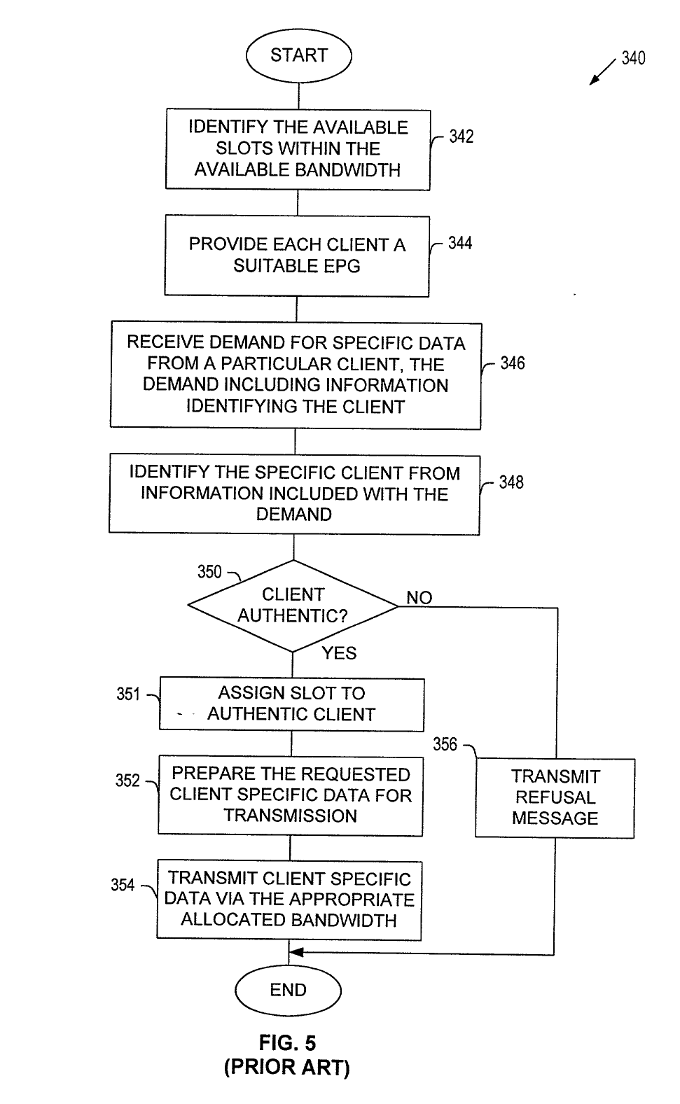

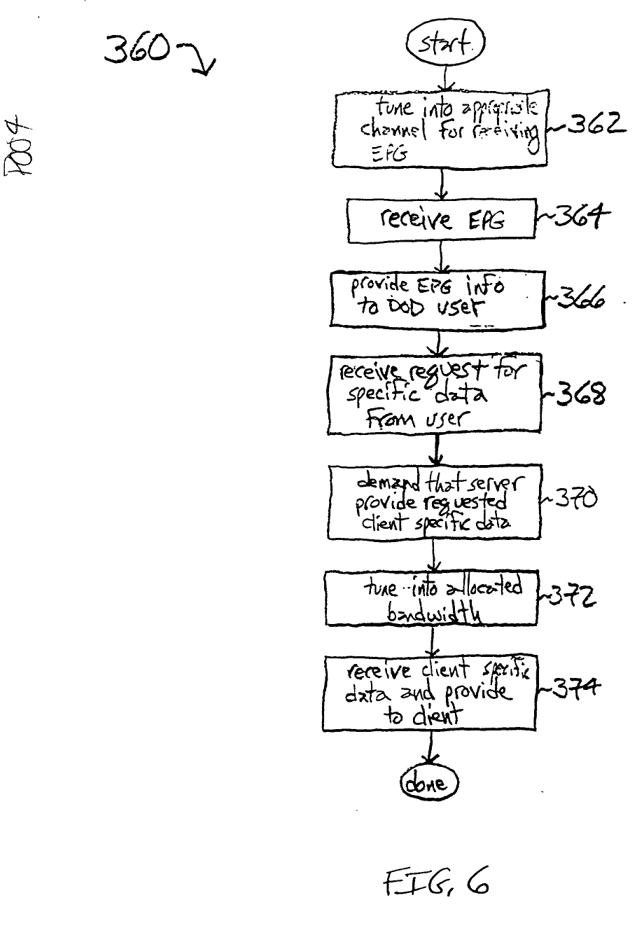

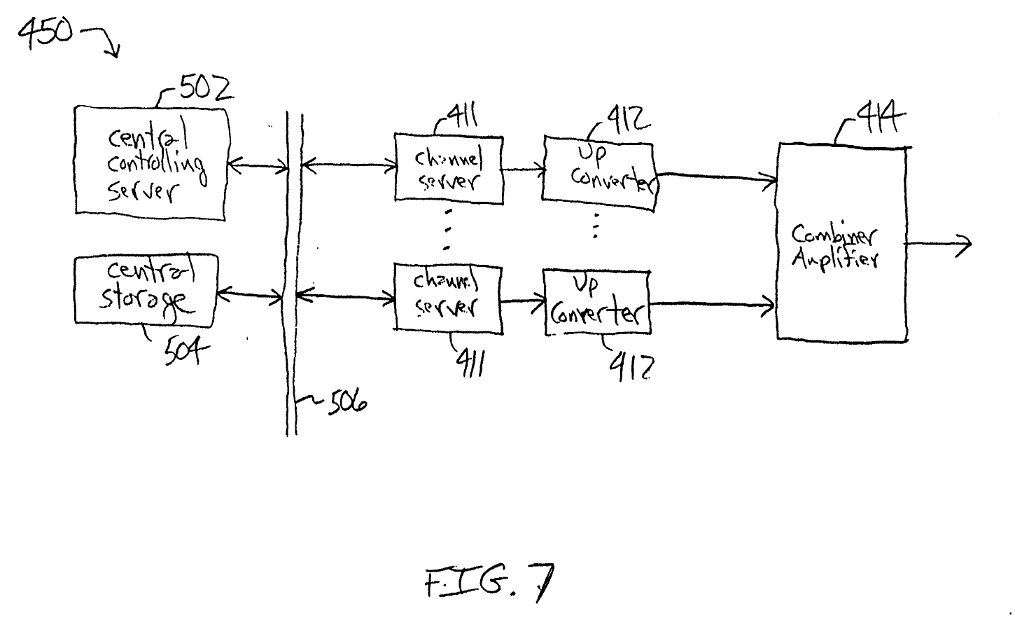

FIG. 7 illustrates the architecture for a VOD server 450 in accordance with one embodiment of the present invention. The VOD server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described below, the central controlling server 502 controls off-line operation of the channel servers 411, as well as initiating real-time transmission once the channel servers 411 are ready. The central storage 504 typically stores data files in a digital format. However, any suitable mass persistent data storage device may be used.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data for VOD is performed “off-line” to fully prepare each channel server 411 for real-time data transmission. Each channel server 411 informs the central controlling server 502 when ready to provide VOD, at which point the central controlling server 502 can control the channel servers 411 to begin VOD transmission.

In a preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing unidirectional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

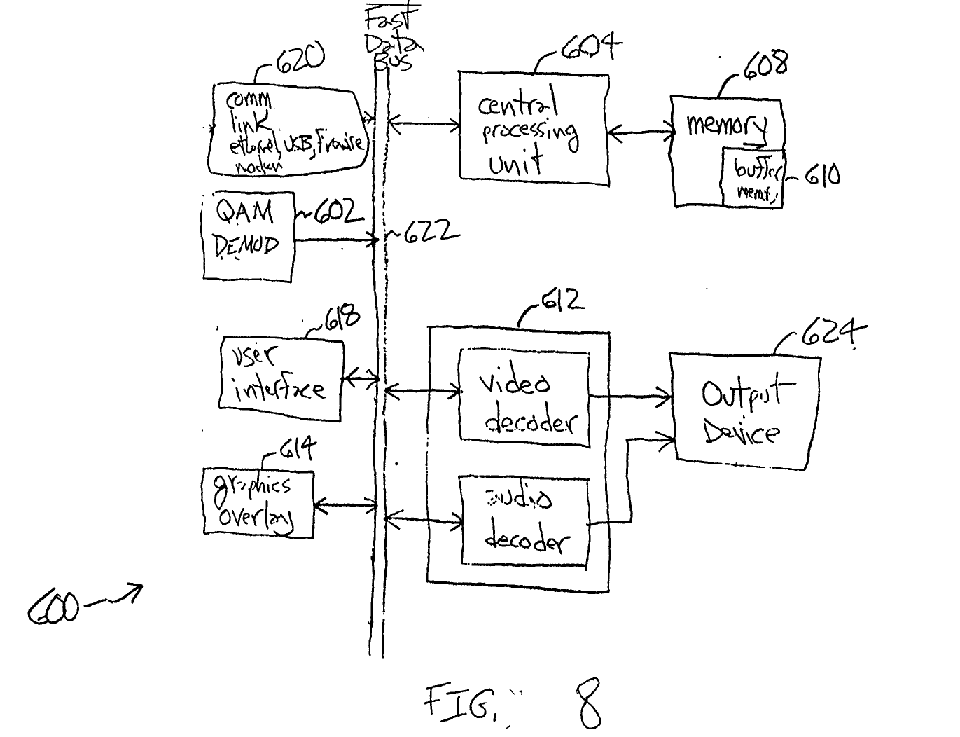

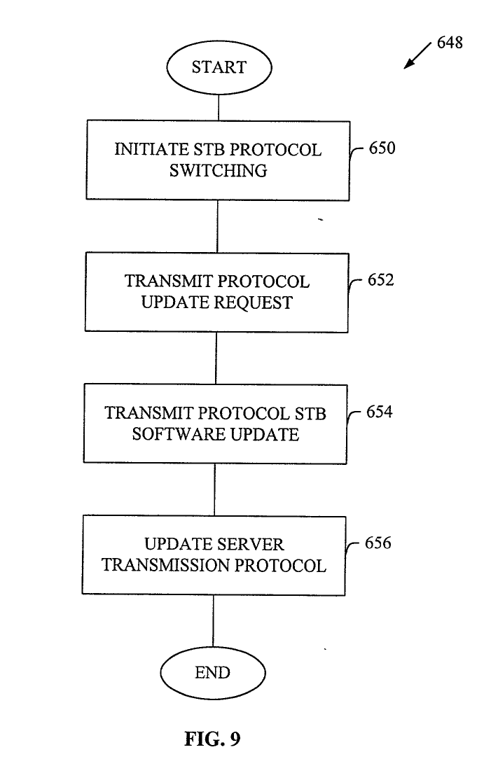

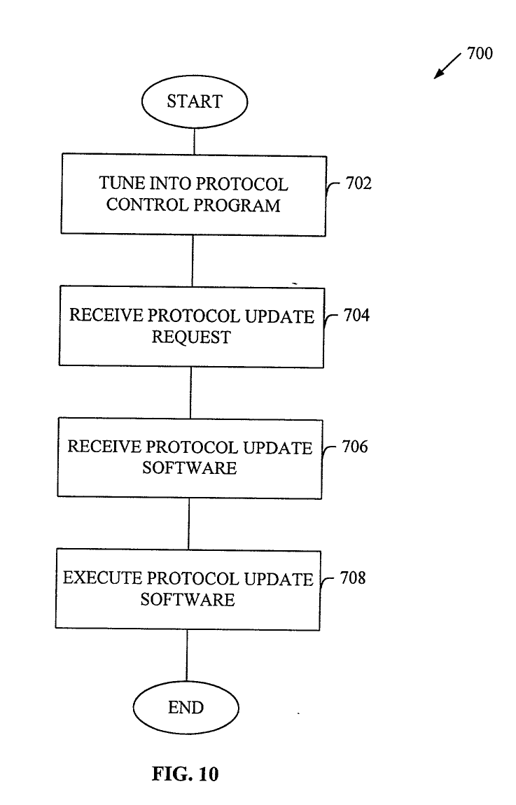

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 10.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 412 are applied to the combiner/amplifier 414. The combiner/amplifier 414 amplifies, conditions and combines the received RF signals then outputs the signals out to a transmission medium using a communications protocol. In one embodiment, an authenticity checker is embedded in one or more of the output signals. This authenticity checker is operative to determine whether a receiving STB is counterfeit and to perform ani-counterfeit measures upon the STB if it is counterfeit. The operation of the authenticity checker is discussed in greater detail below. In one embodiment, the communication protocol is periodically changed in order to prevent counterfeit STBs using an earlier communication protocol from deciphering the signals.

FIG. 8 illustrates a universal STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises non-volatile memory (e.g., a hard drive) and the buffer memory 610 comprises volatile memory.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data using the same communications protocol used by the combiner/amplifier 414 (FIG. 7) in transmitting the signals.

In an exemplary embodiment, when access is granted, the decoder 612 decodes at least one data block to transform the data block into images displayable on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like. The STB 600 may be incorporated into an advanced display device so as to appear as a single unit instead of sitting on top of a display device.

The graphics overlay module 614 enhances displayed graphics quality by, for example, providing alpha blending or picture-in-picture capabilities. The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc.

In a preferred embodiment, one or more of the data blocks may contain an authenticity checker which is software executed by the central processing unit 604. The authenticity checker performs an authenticity check of the STB in order to determine whether the STB is authentic or counterfeit.

There are many ways in which the authenticity checker may determine whether an STB is counterfeit. In one embodiment the authenticity checker performs a cyclic redundancy check (CRC) on a location in the STB 600 in order to determine authenticity. In another embodiment the authenticity checker performs an image check of the STB system. In another embodiment the authenticity checker queries a location hidden in the STB hardware, if the location responds the STB is determined to be authentic. In yet another embodiment the authenticity checker performs a checksum on a memory location. Any other appropriate check may be used to determine authenticity. The actual implementation of such checks are well known in the art.

If the STB is counterfeit the authenticity checker may perform anti-counterfeit operations or may cause other software or hardware on the STB to perform anti-counterfeit measures. In an exemplary embodiment the authenticity checker disables or damages the STB. The authenticity checker may add or delete STB software rendering the STB inoperable, or cause the central processor 604 to overheat by executing an infinite loop program, or perform any other appropriate action in order to disable the counterfeit STB.

In an alternative embodiment the authenticity checker may be a hardware device located in the STB or software stored in memory 608. In this case the authenticity would perform a check every time the STB was turned “ON” or at some regular interval. Having the authenticity checker built into the STB 600 is not ideal because it allows counterfeiters access to the authenticity checker.

FIG. 9 shows a communications protocol switching process at 648 in accordance with one embodiment of the present invention. The process 648 begins at step 650, in which the VOD server 450 (FIG. 7) initiates switching to a new communications protocol. This may be performed at a regular interval or at any time VOD server administrators feel it is appropriate to change communications protocol.

The process 648 proceeds to step 652, in which the VOD server 450 (FIG. 7) transmits a protocol update request. This request induces all authentic STBs to prepare to update their communications protocol and contains information indicating the time and transmission channel of the communication update data transmission as well as when the new protocol is to be implemented. Then in step 654 the VOD server transmits the communications protocol update data. This data is stored in the memory 608 (FIG. 8) of the STB until the VOD server transmission begins transmitting using the updated communications protocol. Then in step 656 the VOD server begins transmitting all data using the updated communications protocol. In an alternative embodiment the authenticity checker is transmitted with the protocol update request in step 652.

FIG. 10 shows an STB communications protocol update process at 700 in accordance with one embodiment of the present invention. The process begins at step 702, in which the communications link 620 (FIG. 8) listens for the protocol update program. In accordance with an exemplary embodiment the communications link listens at a dedicated update channel (not shown) for the protocol update program whenever the STB is “ON”.

Alternatively the STB may be programmed to automatically turn on and listen at a predetermined channel for the update protocol program at a predetermined time. For example, the STB may be programmed by a manufacturer to turn on at 4 am every Monday and listen at channel 99 for update programs.

When the VOD server transmits a protocol update request the process continues to step 704, in which the STB receives the protocol update request. The request alerts the STB to prepare for an impending communications protocol update. In an alternative embodiment the authenticity checker is embedded in or transmitted with the protocol update request. The authenticity checker would immediately perform an authenticity check and disable an STB determined to be counterfeit.

In step 706 the STB receives the communications protocol update data and stores the data in memory 608 (FIG. 8). In an exemplary embodiment the communications protocol update data includes date and time information indicating when the VOD server 450 (FIG. 7) will begin broadcasting with the updated communications protocol as well as software for updating or overwriting the STB's existing communications protocol.

At the specified date and time the VOD server is to begin broadcasting with the updated communications protocol or the process continues to step 708, in which the central processing unit 604 (FIG. 8) executes the communications protocol update software. The communications protocol update software updates the existing communications protocol in order to enable the STB to decipher data transmitted using the updated communications protocol.

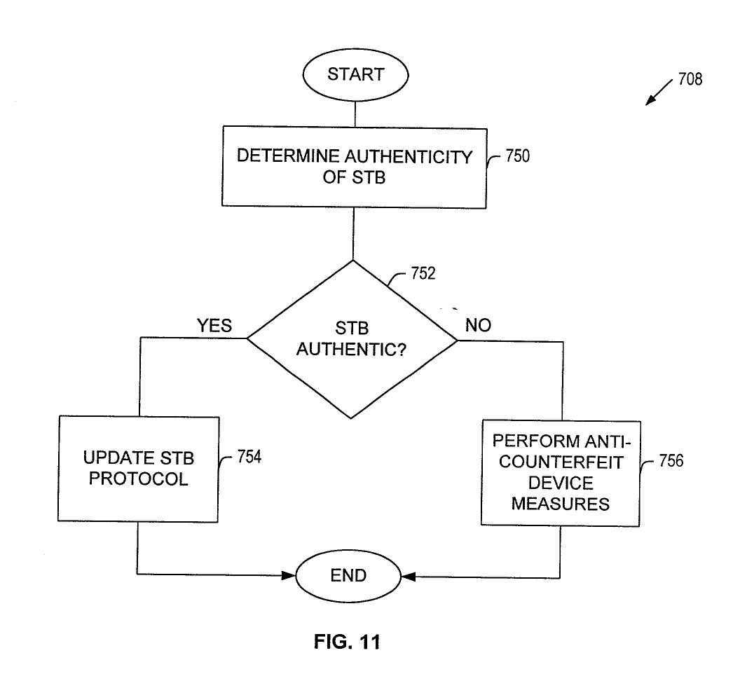

FIG. 11 shows the process for executing the communications protocol update at 708 in accordance with one embodiment of the present invention. Beginning at step 750, an authenticity check is executed to determine whether the STB is counterfeit or authentic. This authenticity check may be stored as software and executed by the central processing unit 604 (FIG. 8) or may be performed by dedicated hardware hidden in the STB. The authenticity check performed may be one or more of the following checks: a cyclic redundancy check (CRC) performed on a memory or hardware location; a checksum performed on a memory or hardware location; querying a hidden location within the STB hardware; and performing an image check of the entire STB system. The actual implementation of such checks are well known in the art.

If the STB passes the authenticity check then the process continues to step 754, in which the communications protocol the STB uses to decipher signals received is updated. This updating takes the form of overwriting some or all of the existing communications protocol software stored in memory 608 (FIG. 8).

If the STB fails the authenticity check, it is determined to be counterfeit and the process continues to step 756. In step 756 anti-counterfeit measures are performed. In an exemplary embodiment the counterfeit STB is disabled. This may be done by instructing the central processing unit 604 (FIG. 8) to execute a program which will either damage itself or erase vital portions of the software stored in the memory 608 (FIG. 8). These instructions may be loaded in the memory at the time of manufacture or included in the software of the authenticity check. In an alternative embodiment no drastic anti-counterfeit measures are performed, the STB communications protocol simply not being updated.

In another alternative embodiment, when used with a bi-directional DOD server the anti-counterfeit software may send a message to the VOD server 450 (FIG. 7) informing the server administrators of the location of the counterfeit STB. It should also be noted that in either a unidirectional or bi-directional broadcast system, the anti-counterfeit software may send a message to a site other than the VOD server. This message may be sent by whatever communication means the counterfeit STB has access.

As stated earlier the authenticity checker may be in any portion of the transmission signal, but is most preferably in the protocol update part of the transmission signal. This is beneficial for two reasons. One is that the authenticity checker may be run in what is already, extensibly, a maintenance running program, as opposed to using resources while a STB is trying to run, for example, a DOD file. The second reason is that this provides an inherent opportunity to police a counterfeit device.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A set-top-box (STB) comprising:
a databus;
a first communication device suitable for coupling to a digital broadcast communications medium, said first communication device operable to receive digital broadcast data;
memory bi-directionally coupled to said databus, said memory including computer executable instructions for:
a) determining whether said STB is authentic or counterfeit; and
b) performing anti-counterfeit measures upon said STB when said device is determined to be counterfeit;
a digital data decoder bi-directionally coupled to said databus;
a central processing unit (CPU) bi-directionally coupled to said databus, said CPU implementing a STB control process controlling said memory, said first communications device and said digital decoder, said STB control process operable to process digital data received at said first communications device.

2. A STB as recited in claim 1, wherein said memory includes transient random access memory (RAM) and a persistent storage device, and said computer executable instructions are stored on said persistent storage device.

3. A STB as recited in claim 2, wherein said persistent storage device is a hard disk.

4. A STB as recited in claim 1, further comprising an STB authenticity code hidden with the STB hardware, wherein said computer executable instructions for determining whether said STB is authentic or counterfeit includes a computer executable instruction for performing an integrity check upon said hidden STB authenticity code.

5. A STB as recited in claim 4, wherein said integrity check involves performing a cyclic redundancy check.

6. A STB as recited in claim 4, wherein said integrity check involves performing a checksum on said STB authenticity code.

7. A STB as recited in claim 4, wherein said integrity check involves querying a location wherein said STB authenticity code is hidden.

8. A STB as recited in claim 4, wherein said integrity check involves performing an image check upon said STB.

9. A STB as recited in claim 1, wherein said determining whether said STB is authentic or counterfeit involves performing an image check on the STB hardware.

10. A STB as recited in claim 4, wherein said performing anti-counterfeit measures upon said STB when said device is determined to be counterfeit includes disabling said STB.

11. A STB as recited in claim 4, wherein said performing anti-counterfeit measures upon said STB when said device is determined to be counterfeit includes damaging said STB.

12. A STB as recited in claim 4, wherein said performing anti-counterfeit measures upon said STB when said device is determined to be counterfeit includes transmitting a signal to a broadcast server site indicating that said STB is counterfeit.

13. A STB as recited in claim 12, wherein said signal includes information on the location of said STB.

14. A STB as recited in claim 1, wherein said memory further includes computer executable instructions for updating a communications protocol of said STB when said STB is determined to be authentic.

15. A STB as recited in claim 14, wherein said updating a communications protocol of said STB includes updating said communications protocol in order to enable said STB to decode a broadcast signal encoded using an associated updated protocol.

16. A STB as recited in claim 15, wherein said broadcast signal encoded using said associated updated protocol is transmitted at a predetermined point in time.

17. A STB as recited in claim 16, wherein said STB is no longer able to decode broadcast signals encoded using the protocol used to encode broadcast signals transmitted before said predetermined point in time.

18. A STB as recited in claim 15, wherein said updating a communications protocol of said STB includes listening at a predetermined time and channel for a signal containing information for enabling said STB to decipher said updated protocol.

19. A STB as recited in claim 1, further comprising an STB authenticity code hidden with the STB software, wherein said computer executable instructions for determining whether said STB is authentic or counterfeit includes a computer executable instruction for performing an integrity check upon said hidden STB authenticity code.

20. A STB as recited in claim 18, wherein said updating a communications protocol of said STB includes altering at least a portion of said STB's existing communications protocol such that said STB is able to decipher signals transmitted using an updated communications protocol.

21. A STB as recited in claim 1, wherein said STB includes a graphic display device for displaying said digital broadcast data.

22. A set-top-box (STB) comprising:
a databus;
a first communication device suitable for coupling to a digital broadcast communications medium, said first communication device operable to receive digital broadcast data;
memory bi-directionally coupled to said databus, said memory including computer executable instructions for:
a) determining whether said STB is authentic or counterfeit;
b) performing anti-counterfeit measures upon said STB when said device is determined to be counterfeit; and
c) updating a communications protocol of said STB when said STB is determined to be authentic;
a digital data decoder bi-directionally coupled to said databus;
a central processing unit (CPU) bi-directionally coupled to said databus, said CPU implementing a STB control process controlling said memory, said first communications device and said digital decoder, said STB control process operable to process digital data received at said first communications device.

23. A STB as recited in claim 22, wherein said memory includes transient random access memory (RAM) and a persistent storage device, and said computer executable instructions are stored on said persistent storage device.

24. A STB as recited in claim 23, wherein said persistent storage device is a hard disk.

25. A STB as recited in claim 22, further comprising an STB authenticity code hidden with the STB hardware, wherein said computer executable instructions for determining whether said STB is authentic or counterfeit includes a computer executable instruction for performing an integrity check upon said hidden STB authenticity code.

26. A computer implemented method for authenticating validity of a data receiving system such as a set-top-box, said computer implemented method comprising the act of:
transmitting to said data receiving system an anti-counterfeit software application executable by said data receiving system, said anti-counterfeit software operable to determine whether said data receiving device is counterfeit or authentic, said anti-counterfeit software further operable to perform anti-counterfeit measures at said data receiving system.

27. A method as recited in claim 26, wherein said data receiving system includes a communications protocol for deciphering data signals and when said data receiving system is determined to be authentic, said anti-counterfeit software application being further operable to update said communications protocol.

28. A method as recited in claim 27, wherein said anti-counterfeit software application is further operable to send a message to a predetermined location.

29. A method as recited in claim 28, wherein said sending a message is sent via the internet.

30. A method as recited in claim 28, wherein said predetermined location is a bi-directional DOD server.

31. A method as recited in claim 28, wherein said message is sent via a telephone connection.

32. A method as recited in claim 28, wherein said message is sent via a broadband connection.

33. A method as recited in claim 28, wherein said message is sent via a cable modem.

34. A counterfeit counter measure for transmission signal processors comprising:
a transmission signal;
an authenticity checker that is embedded in said transmission signal;
a transmission signal processor;
an authenticity verification that is embedded in said transmission signal processor;
wherein said authenticity checker executes once received by said transmission signal processor;
wherein said authenticity checker searches said transmission signal processor for said authenticity verification;
wherein if said authenticity verification is found said transmission signal processor processes said transmission signal properly; and
wherein if said authenticity verification is not found said transmission signal processor is disabled.

35. The counterfeit counter measure for transmission signal processors of claim 34, wherein said authenticity checker is embedded in a protocol update.

36. The counterfeit counter measure for transmission signal processors of claim 34, wherein said authenticity verification is software.

37. The counterfeit counter measure for transmission signal processors of claim 34, wherein said authenticity checker is hardware.

38. The counterfeit counter measure for transmission signal processors of claim 34, wherein when said transmission signal processor no longer functions properly is due to failure of said transmission signal processor to properly process said transmission signal.

39. The counterfeit counter measure for transmission signal processors of claim 34, wherein when said transmission signal processor no longer functions properly due to said transmission signal processor malfunctioning.

40. The counterfeit counter measure for transmission signal processors of claim 34, wherein said transmission signal is part of a uni-directional transmission system.

41. The counterfeit counter measure for transmission signal processors of claim 34, wherein said transmission signal is part of a bi-directional transmission system.

42. The counterfeit counter measure for transmission signal processors of claim 41, wherein if said authenticity verification is not found, an additionally a signal is sent back to the source of said transmission signal.

43. A set-top box (STB) that receives a data file in data blocks for uni- and bi-directional signal system with a counterfeit countermeasures comprising:
a STB that is incorporated with a data file utilizing device;
a counterfeit countermeasure incorporated with said STB, said counterfeit countermeasure comprising an authenticity verification;
a signal source linked to said STB;
a data file that is broken into data blocks and sent over said signal source to said STB;
an authenticity checker embedded in said data file;
wherein said data is transmitted to said STB;
wherein once said data file is transmitted to said STB, said authenticity checker searches said STB for said authenticity verification; and
wherein if said authenticity verification is found, said data file may be restored from said data blocks and used by said data file utilizing device.

44. The set-top box (STB) that receives a data file in data blocks for uni- and bi-directional signal system with a counterfeit countermeasures according to claim 43, wherein said authenticity checker embedded in said data file is further embedded in a protocol update portion of said data file.
